(19) United States
(12) Patent Application Publication
(10) Pub. No.: US 2016/0352286 A1
(43) Pub. Date: Dec. 1, 2016

(54) SELF-CONTAINED LARGE SCALE COMPUTING PLATFORM

(71) Applicant: California Institute of Technology, Pasadena, CA (US)

(72) Inventors: Seyed Ali Hajimiri, La Canada, CA (US); Behrooz Abiri, Pasadena, CA (US); Florian Bohn, Pasadena, CA (US)

(21) Appl. No.: 15/170,852

(22) Filed: Jun. 1, 2016

Related U.S. Application Data
(63) Continuation of application No. 62/169,135, filed on Jun. 1, 2015.

(51) Int. Cl. H02S 40/42; H02S 30/20; H02S 20/32; H02S 10/40

(52) U.S. Cl. CPC H02S 40/42; H02S 10/40; H02S 30/20; H02S 20/32

(57) ABSTRACT

A massively parallel computer system (MPCS) includes a multitude of tiles each adapted to include one or more processing/memory units, power generation unit, and associated circuitry. The tiles are formed in an array of thin, light-weight material that may be foldable and/or collapsible to enable the packaging and folding of the MPCS into a small amount of volume for launch into space. The power generation units may be photovoltaic cells or solar panels that generate DC energy from sun light. The DC energy powers the processing units, memory and other circuits of the MPCS. Heat dissipating structures disposed in the MPCS transfer heat away from the processing/memory unit and into space. Communication between the processing units and earth-based systems may be accomplished using any number of communication protocols and mediums. A control unit disposed in the MPCS may maintain the solar panels towards the sun as the MPCS orbits the earth.

### CROSS REFERENCE TO RELATED APPLICATIONS

The present application claims benefit under 35 USC 119(e) of U.S. provisional Application No. 62/169,135, filed Jun. 1, 2015, entitled “Massively Parallel Computational Platforms in Space”, the content of which is incorporated herein by reference in its entirety.

### FIELD OF THE INVENTION

The present invention relates to computational systems, and more particularly to self-powered, self-cooling computational systems.

### BACKGROUND OF THE INVENTION

The increasing need for computational power has driven the growth of data storage and computation centers such as Amazon's AWS cloud products. The energy consumed by such centers is estimated to exceed 90 billion kWh and is expected to continue growing in the future. These centers consume large amounts of real estate, electrical power and pose significant cooling challenges as well as significantly contributing to carbon emission into the atmosphere. As the market for cloud computing and storage increases, alternative approaches that have less harmful effect on the environment are highly desirable.

### BRIEF SUMMARY OF THE INVENTION

A computing/communication system, in accordance with one embodiment of the present invention includes, in part, a substrate, a multitude of integrated circuits disposed on a first surface of the substrate, and a multitude of photovoltaic cells disposed on a second surface of the substrate. Each of the multitude of photovoltaic cells is adapted to convert sun light to electrical energy and supply the electrical energy to a different one of the integrated circuits.

In one embodiment, the computing/communication system further includes, in part, a control unit adapted to transfer data between the integrated circuits and a remote server. In one embodiment each integrated circuit is adapted to communicate with a subset of nearest neighbors integrated circuits. In one embodiment, each integrated circuit is further adapted to communicate with a remote server wirelessly via a transmit/receive antenna.

In one embodiment, the computing/communication system is further adapted to operate in space. In such embodiments, the control unit may be operated to maintain the second surface of the substrate facing towards the sun as the computing/communication system orbits the earth.

In one embodiment, each integrated circuit includes, in part, a data/signal processing unit. In one embodiment, each integrated circuit includes, in part, a memory. In yet other embodiments, each integrated circuit includes, in part, a data/signal processing unit and a memory.

In one embodiment, the substrates are made from flexible and/or collapsible materials such as Kapton, polyimide and polytetrafluoroethylene. In one embodiment, to dissipate heat into space, a heat dissipating structure associated with each integrated circuit is formed. In one embodiment, each heat dissipating structure includes a multitude of concentric shapes formed using metallic or heat conducting materials. The dissipating structures may be disposed on the first or second surface of the substrate. In one embodiment, each heat dissipating structure has a tapered shaped with a thickness that decreases with distance away from the heat dissipating structure's associated integrated circuit.

A method of forming a computing/communication system, in accordance with one embodiment of the present invention, includes, in part, forming a multitude of integrated circuits on a first surface of the substrate, and forming a multitude of photovoltaic cells on a second surface of the substrate. Each photovoltaic cell is adapted to convert sun light to electrical energy and supply the electrical energy to a different one of the integrated circuits.

In one embodiment, the computing/communication system further includes, in part, a control unit adapted to transfer data between the integrated circuits and a remote server. In one embodiment each integrated circuit is adapted to communicate with a subset of nearest neighbors integrated circuits. In one embodiment, each integrated circuit is further adapted to communicate with a remote server wirelessly via a transmit/receive antenna.

In one embodiment, the computing/communication system is further adapted to operate in space. In one embodiment, the method further includes, in part, maintaining the second surface of the substrate facing the sun as the computing/communication system orbits the earth.

In one embodiment, each integrated circuit includes, in part, a data/signal processing unit. In one embodiment, each integrated circuit includes, in part, a memory. In yet other embodiments, each integrated circuit includes, in part, a data/signal processing unit and a memory.

In one embodiment, the substrates are made from flexible and/or collapsible materials such as Kapton, polyimide and polytetrafluoroethylene. In one embodiment, to dissipate heat into space, a heat dissipating structure associated with each integrated circuit is formed. In one embodiment, each heat dissipating structure includes a multitude of concentric shapes formed using metallic or heat conducting materials. The dissipating structures may be disposed on the first or second surface of the substrate. In one embodiment, each heat dissipating structure has a tapered shaped with a thickness that decreases with distance away from the heat dissipating structure's associated integrated circuit or photovoltaic cell.

### BRIEF DESCRIPTION OF THE DRAWINGS

FIG. 1 is a simplified high-level block diagram of a tile of a self-contained massively parallel computer system, in accordance with one embodiment of the present invention.

FIG. 2 is a simplified high-level block diagram of a self-contained massively parallel computer system, in accordance with one embodiment of the present invention.

FIG. 3 is a simplified high-level block diagram of a self-contained massively parallel computer system, in accordance with another embodiment of the present invention.

FIG. 4 is a simplified high-level block diagram of a self-contained massively parallel computer system, in accordance with one embodiment of the present invention.

FIG. 5 shows a tile of a self-contained massively parallel computer system having a packaged integrated circuit disposed thereon, in accordance with one embodiment of the present invention.

FIGS. 6A, 6B and 6C are exemplary embodiments of integrated circuits that may be disposed on a tile of a self-contained massively parallel computer system, in accordance with one embodiment of the present invention.

FIG. 7A is a simplified view of a multitude of photovoltaic cells disposed on a back surface of a tile of a self-contained massively parallel computer system, in accordance with one embodiment of the present invention.

FIG. 7B is a simplified view of a back surface of a tile of a self-contained massively parallel computer system, in accordance with another embodiment of the present invention.

FIG. 8A is an exemplary heat dissipating structure, in accordance with one embodiment of the present invention.

FIG. 8B is an exemplary heat dissipating structure, in accordance with one embodiment of the present invention.

FIG. 8C is an exemplary heat dissipating structure, in accordance with one embodiment of the present invention.

FIGS. 9A and 9B are exemplary profiles of the thickness of the heat dissipating structures shown in FIGS. 8A and 8B.

FIG. 9C shows exemplary temperature variations across the heat dissipating structure shown in FIG. 8B, in accordance with one embodiment of the present invention.

FIG. 10A shows the maximum temperature in Kelvin at the heat dissipating structures of FIGS. 8A, 8B, 8C as a function of the power consumed by the heat dissipating structure's associated integrated circuits in accordance with one embodiment of the present invention.

FIG. 10B show the maximum temperature as a function of the power consumption for three different volumes of the heat dissipating structure of FIG. 8B having an emissivity of 0.8, in accordance with one embodiment of the present invention.

FIG. 11 show the maximum temperature as a function of the power consumption for three different volumes of the heat dissipating structure of FIG. 8B having an emissivity of 0.5, in accordance with one embodiment of the present invention.

### DETAILED DESCRIPTION OF THE INVENTION

In accordance with one embodiment of the present invention, a massively parallel computer system is powered and cooled locally. The massively parallel computer system (MPCS) includes a multitude of processing units (e.g., a CPU) and associated circuitry. In one embodiment, the MPCS includes a multitude of tiles each adapted to include a processing unit, power generation unit, and associated circuitry, as described below. The tiles are formed in an array of thin, light-weight material. In one embodiment, the thin, light-weight material forming the tiles are foldable and/or collapsible to enable the packaging and folding of the MPCS into a small amount of volume.

The flexibility, and light weight of an MPCS, in accordance with embodiments of the present invention, enables the MPCS to launched into and operate in space. The power generation units disposed in the tiles in the form of photovoltaic cells and solar panels enable power to be obtained from the solar radiation. Heat generated from the operation of the MPCS is dissipated into the space.

Communication between the tiles and processing units may be accomplished using any number of protocols, wired or wireless, and any mediums such as, fiber optics, metal conductors, via wireless signals or other suitable means. The tiles may be adapted to communicate with other computing/communication systems (both earth-based and space-based systems) directly, or alternatively via a central communication system/hub orbiting the earth and which may be disposed on the MPCS or on another space-based computing platform.

Because full insolation in space amounts to, for example, approximately 1350 W/m², usable DC power for computation/communication or other signal processing tasks is proportional to the area used for collection. Assuming a photovoltaics conversion efficiency of 30%, about 400 W/m² would be available for computation/communication or other signal processing tasks, an amount that is comparable to the power consumption of a reasonably powerful small server blade.

Therefore, in accordance with embodiment of the present invention, a surface area of approximately 2 km×2 km running at full power for a year could, may provide 14 billion kWh for computational/communication tasks. Furthermore, since the heat is dissipated into space and no additional power may be needed for cooling, the power generated by the photo-voltaic cells can be fully used for powering the computation/communication devices.

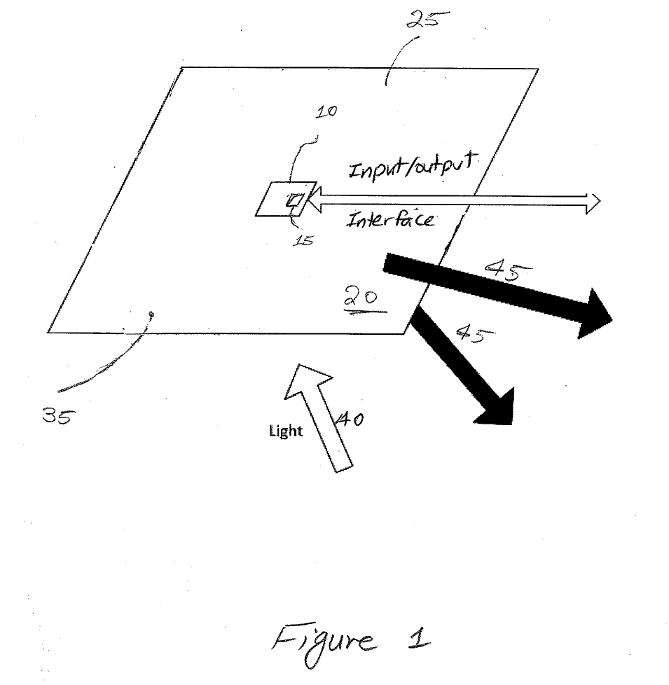

FIG. 1 is a simplified high-level block diagram of a tile 20 of an MPCS, in accordance with one embodiment of the present invention. Tile 20 is shown as having a first surface 25 having disposed thereon, one or more integrated circuits (IC), collectively referred as IC 10. Tile 20 is also shown as having a second surface 35 having disposed thereon one or more photovoltaic cells (not shown)—adapted to convert sun light 40 into DC power and supply the DC power to IC 10 either through metal conductors or wirelessly. Solar cells may use concentrators (e.g. parabolic mirrors) to reduce the area and thus the overall weight of the MPCS. Heat generated by IC 10 and the photovoltaic cells is dissipated into the surrounding space along many directions, such as direction 45 shown in FIG. 1.

IC 10 is adapted to process and store data and may include, for example, one or more data processing units, such as microcontrollers, microprocessors, digital signal processors, application specific integrated circuits (ASIC), field-programmable gate array, and the like. IC 10 may also include one or more storage elements, such as DRAMs or flash memory. IC(s) 10 are adapted to communicate with other ICs disposed on the MPCS, or with other earth or space-based system via interface unit 15 of IC 10.

In one embodiment, tile 20 is formed using a relatively thin and light material such as polyimide, Kapton™, PTFE (polytetrafluoroethylene), Teflon™ based substrates, and the like. In one embodiment, IC 10 is thinned down and coupled to tile 20 via an interposer, such as a flip-chip or wirebond package or substrate. IC 10 may communicate with other tiles disposed on the same MPCS or with other MPCS (both earth-based and space-based systems) using any number of wired or wireless communication protocols/links, and any mediums such as, fiber optics, metal conductors, antennas, and the like. While in Earth's orbit, a control unit maintains surface 35 facing towards the sun and IC 10 away from the sun (toward the dark space background) so as to facilitate thermal radiation and cooling of IC 10 as well as maintain insolation from the sun for power generation

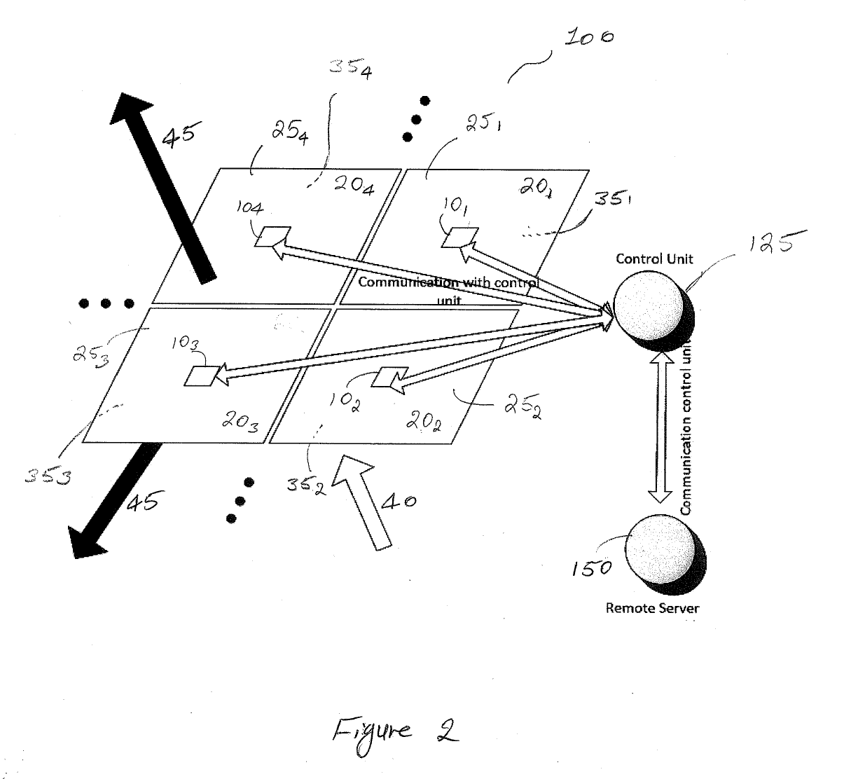

FIG. 2 is a simplified high-level block diagram of an MPCS 100, in accordance with one embodiment of the present invention. Although MPCS 100 is shown as including four tiles 20₁, 20₂, 20₃ and 20₄, it is understood that an MPCS in accordance with embodiments of the present invention, may include any number of tiles 20ᵢ, where i is an integer index greater than one. Each tile 20ᵢ is shown as including one or more associated integrated circuits 10ᵢ on its first surface 20ᵢ. Each tile 20ᵢ also includes a second surface 35ᵢ having one or more photovoltaic cells 50ᵢ (not shown) adapted to convert sunlight into DC power for powering the tile's associated integrated circuits 10ᵢ. In the embodiment shown in FIG. 2, ICs 10ᵢ are adapted to communicate with remote server 150 via control unit 125. Control unit may be disposed on MPCS 100, on a satellite orbiting the earth or an earth-based system. MPCS 100 together with control unit 125 form a server network having a wireless transponder which allows for transfer of data to a remote location such as earth-based server 50. Although in FIG. 2, tiles 20₁, 20₂, 20₃ and 20₄ are shown as being physically separate substrates, it is understood that in other embodiments, a single substrate may include two or more tiles. In embodiments in which a single substrate may include two or more tiles, the individual substrates may be joined together via, for example, a cable made from the same material as the substrates. The substrates so joined thus form a larger substrate to enable the formation of a modular computation/communication system to satisfy the multipronged requirements of processing power, ease of launch into space, and heat dissipation, and the like. During the launch of the MPCS into space, the various substrates may be folded together. Once placed in Earth's orbit, the substrates are then unfolded to maximize exposure to sun light.

MPCS 100 is adapted to have a relatively light weight to facilitate its launch into space. Accordingly, in one embodiment, MPCS operates while orbiting the Earth. Each tile 20ᵢ is formed using a relatively thin and light material such as polyimide, Kapton, PTFE, Teflon™ based substrates, and the like. In one embodiment, each IC 10ᵢ is thinned down coupled to tile 20 via an interposer, such as a flip-chip or wirebond package or substrate. An IC 10, may communicate with other tiles disposed in its vicinity on the same MPCS or with other MPCS (both earth-based and space-based systems) using any number of wired or wireless communication protocols/links, and any mediums such as, fiber optics, metal conductors, antennas, and the like. While in Earth's orbit, a control unit maintains surface 35 facing towards the sun and IC 10 away from the sun (toward the dark space background) so as to facilitate thermal radiation and cooling of IC 10.

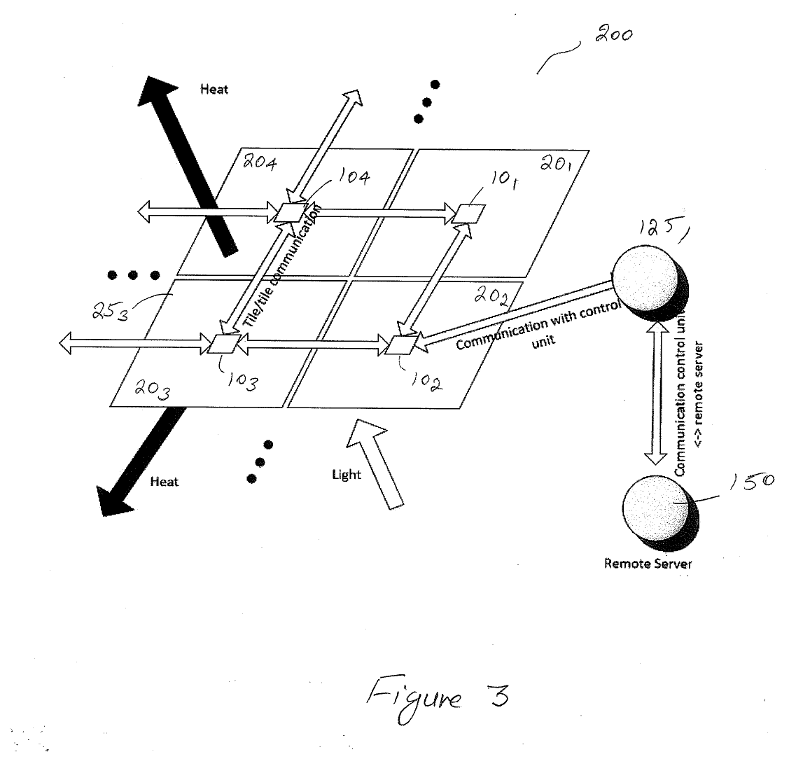

FIG. 3 is a simplified high-level block diagram of an MPCS 200, in accordance with another embodiment of the present invention. MPCS 200 is similar to MPCS 100 except that in MPCS 200, ICs 10ᵢ are adapted to communicate with one or more of their nearest neighbors, or second nearest neighbors, etc. ICs 10ᵢ are also adapted to communicate with control unit 125 and remote server 150. The communication between the tiles (and ICs) can be accomplished via the same interface used to connect to a central unit or via one or multiple different dedicated electronic busses (such as I2C, SPI, RS-232, USB or other suitable bus architectures).

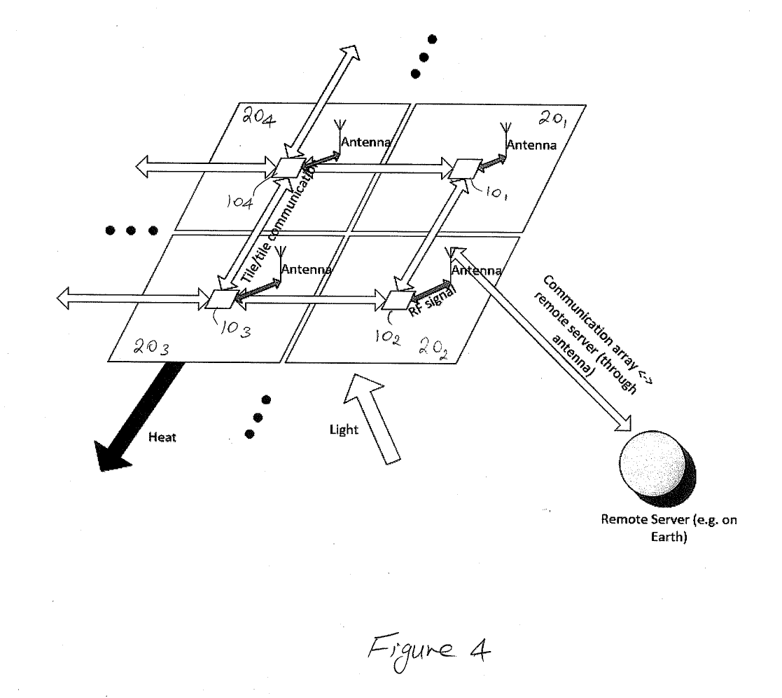

FIG. 4 is a simplified high-level block diagram of an MPCS 300, in accordance with another embodiment of the present invention. MPCS 300 is similar to MPCS 200 except that in MPCS 300 each tile is adapted to communicate with one or more of its nearest neighbors, or second nearest neighbors, etc. in a peer-to-peer manner, and further to transmit data to earth-based remote server 150 through a wireless communication medium and protocol (collectively referred to herein as link). The wireless links associated with the tile collectively may be used to form a phased array transmitter such that the RF power from all tiles add coherently on a specific location on earth. Since the overall phased array transmitter has a much higher gain that each individual tile, less power is consumed for data transmission. Furthermore, by using the tiles to form a phased array transmitter, the signal received by other unintended receivers on earth is much attenuated and scrambled.

Referring to FIGS. 1-4, to further lower the weight of the tiles and the MPCS when launched and operated in space, in one embodiment ICs 10ᵢ may not be packaged. In yet other embodiments, as shown in FIG. 5, the IC is enclosed in a package 55 adapted to partially absorb gamma rays, protons, electrons, neutrons, alpha particles, and the like. Package 55 is shown as being coupled to tile 20 via an interposer 60, such as a flip-chip or wirebond. Electrical connectors (such as solder balls) 70 provide electrical connections between the IC and tile 20. In yet other embodiments, the IC may be connected directly to the tile without using an interposer.

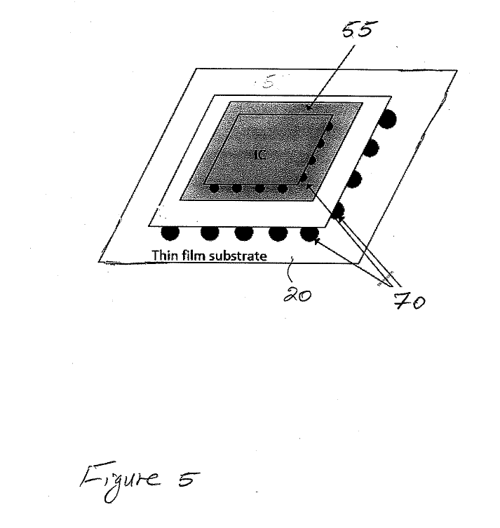

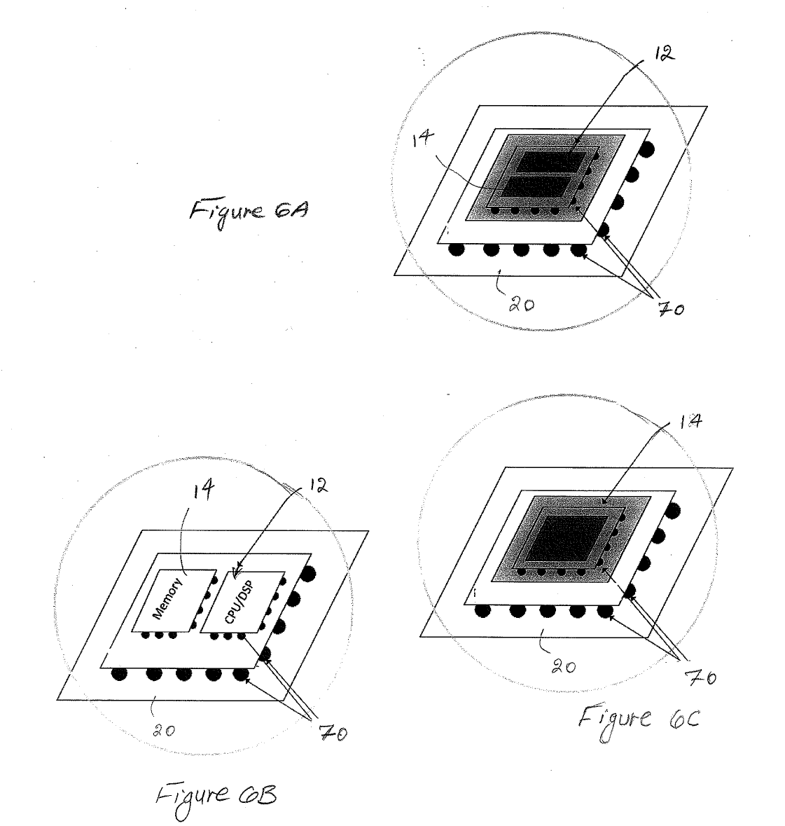

FIGS. 6A, 6B and 6C are exemplary embodiments of the ICs that may be disposed on each tile. In FIG. 6A, the IC(s) disposed on tile 20 is shown as including a central processing unit (CPU) and associate logic 12 as well as memory 14. Memory 14 may be a RAM, Flash memory, EEPROM, DRAM, or any other memory device. Memory 14 and CPU/Logic 12 may be integrated on the same die, or on separates dies. Memory 14 may be used to store, among other things, software instructions executed by the CPU/logic 12, one or more operating systems and/or application specific software, data and calculation results. Memory 14 may also be used to store user data for subsequent retrieval (i.e. cloud functionality). In FIG. 6B, the IC(s) disposed on tile 20 is shown as including a central processing unit (CPU) or digital signal processing (DSP) 12 as well as memory 14. In FIG. 6C, the IC(s) disposed on tile 20 is shown as including memory 14. It is understood that a tile 20 may include any number or combination of integrated circuits.

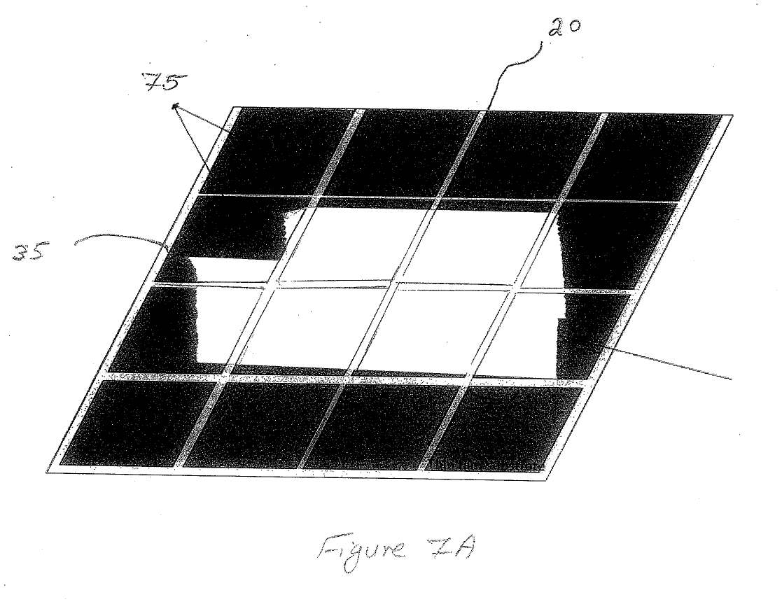

FIG. 7A is a simplified view of the back surface 35 of a tile 20 as shown in FIGS. 1-4, in accordance with one embodiment of the present invention. Each tile 20 is shown as including a multitude of photovoltaic cells 75 that convert the sunlight to electrical energy.

FIG. 7B is a simplified view of the back surface of a tile 20, in accordance with another embodiment of the present invention. Tile 20 is shown as including a multitude of parabolic mirrors 78₁, 78₂, 78₃ . . . adapted to concentrate sun's light onto a region of an adjacent parabolic mirror. For example, parabolic mirrors 78₂ is adapted to focus the sun rays 88 onto region 82₁ of the back surface of parabolic mirror 78₁ where a first multitude of photovoltaic cells associated with tile 20 are positioned. Likewise, parabolic mirrors 78₃ is adapted to focus the sun rays onto region 82₂ of the back surface of parabolic mirror 78₂ where a second multitude of photovoltaic cells associated with tile 20 are positioned. Accordingly, fewer photovoltaic cells per unit area is needed to generate the same amount of electrical energy from the light incident on each tile. During the launch of the MPCS into space, the parabolic mirrors may be held in a flat position and unfolded only after the MPCS is placed in Earth's orbit.

Although the exemplary embodiment of FIG. 7B is shown as using parabolic mirrors to focus the light beams, it is understood that any other light focusing device, such as lenses, shaped mirror surfaces, concentrators using dielectric mirrors, near-field or Fresnel lenses made conventionally or from more advanced techniques such as nano-imprinting, and the like, may also be used. In some embodiment, some or all of the integrated circuits and/or photovoltaic cells are physically bonded to each other to save space and weight. For example, memory ICs may be bonded to digital processing ICs to provide a faster, more compact interface.

To dissipate the heat more efficiently, the photovoltaic cells and the ICs may be bonded to or brought into physical contact with metallic or other heat conducting materials such as diamond. The heat generated by the photovoltaic cells and ICs may then be removed via thermal radiation into the empty space.

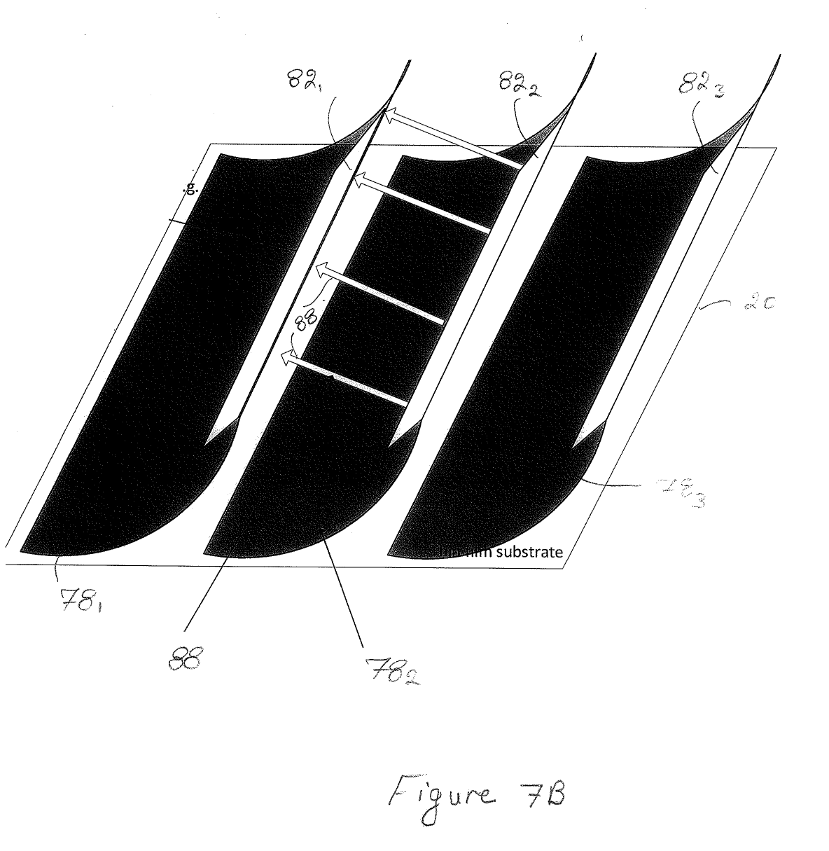

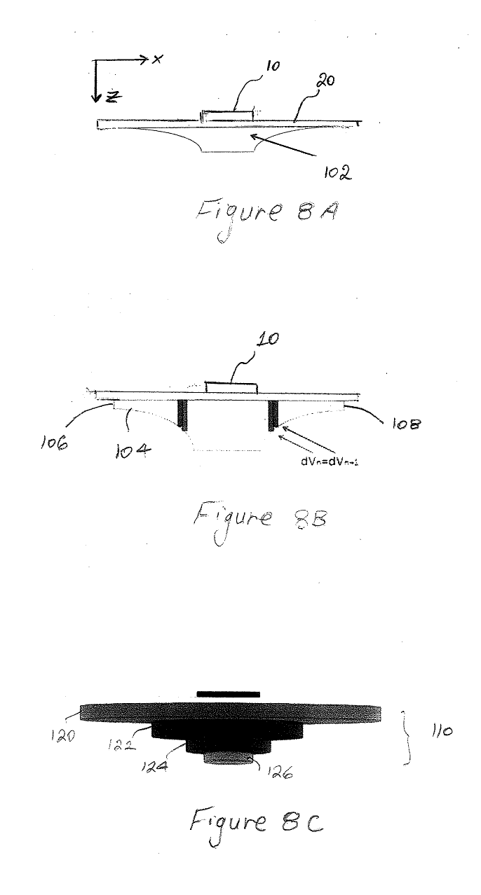

In accordance with one embodiment of the present invention, the heat conducting material, metallic or otherwise, coupled to the IC and/or photovoltaic cells as well as the tile substrate is shaped to improve heat transfer away from the IC and photovoltaic cells. FIG. 8A is an exemplary embodiment of a heat dissipating structure 102 adapted to transfer heat away from IC 10 mounted on tile substrate 20. In this exemplary embodiment, the thickness of heat dissipating structure 102 is assumed to increase along the z-axis in accordance with the expression z=ax². Both z and x axis are shown in FIG. 8A. Although not shown, it is understood that a similar heat dissipating structure may be used for dissipating hear from photovoltaic cells. While in FIG. 8A, IC 10 and heat dissipating structure 102 are shown as being disposed on different surface of substrate 20, it is understood that in other embodiments, the IC as well as the heat dissipating structure may be disposed on the same surface of the substrate.

FIG. 8B is an exemplary embodiment of a heat dissipating structure 104 adapted to transfer heat away from IC 10 mounted on tile substrate 20, in accordance with another exemplary embodiment of the present invention. Heat dissipating structure 104 is shaped so as to have a finite thickness along its edges 106, 108. Although not shown, it is understood that a similar heat dissipating structure may be used for dissipating hear from photovoltaic cells. While in FIG. 8B, IC 10 and heat dissipating structure 104 are shown as being disposed on different surface of substrate 20, it is understood that in other embodiments, the IC as well as the heat dissipating structure may be disposed on the same surface of the substrate.

FIG. 8C is an exemplary embodiment of a heat dissipating structure 110 adapted to transfer heat away from IC 10 mounted on tile substrate 20, in accordance with another exemplary embodiment of the present invention. Heat dissipating structure 110 is shaped so as to have a multitude of concentric cylinders 120, 122, 124 and 126. As is seen from FIG. 8C, the farther a cylinder is from the IC, the shorter is its radius. Although heat dissipating structure 110 is shown as having four concentric heat dissipating cylinders, it is understood that a heat dissipating structure, in accordance with embodiments of the present invention may have fewer or more cylinders. In one embodiment, the concentric cylinders of the heat dissipating structure 100 are made from the same material.

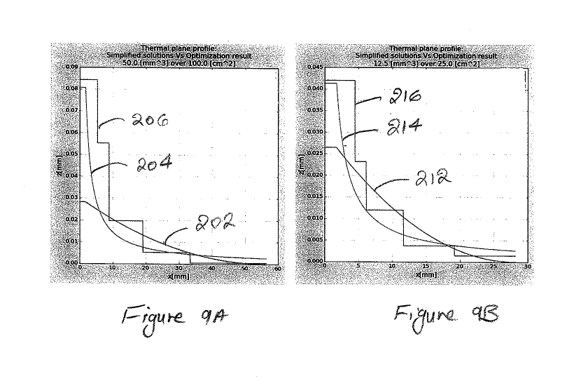

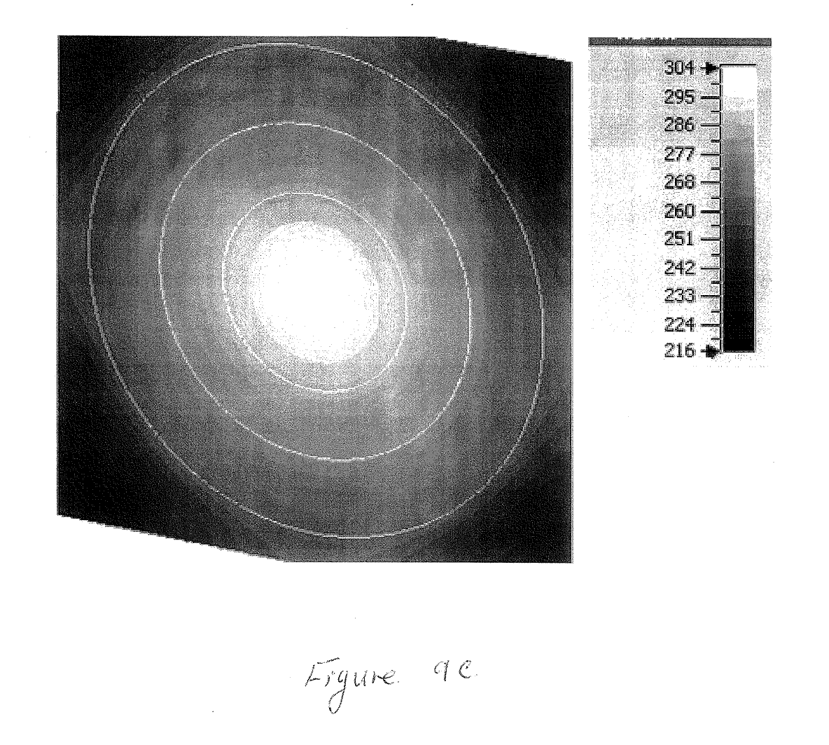

Plots 204, 206 and 208 of FIG. 9A show the thickness along the x-axis of the heat dissipating structures shown respectively in FIGS. 8A, 8B and 8C. In generating these simulations, 50 mm³ of Aluminum is used as heat dissipating structure in a substrate (tie) having an area of 100 cm². Plots 214, 216, 218 of FIG. 9B are similar to plots 204, 206, 208 respectively except that in generating Plots 214, 216, 218, 12.5 mm³ of Aluminum is used as heat dissipating structure in a substrate (tie) having an area of 12.5 cm². FIG. 9C shows the temperature variations across a heat dissipating structure corresponding to plot 204 of FIG. 9A and having an associated IC consuming 0.5 watts of power. As is seen from FIG. 9C, the maximum temperatures at the heat dissipating structure is at 304 Kelvin. The temperate is seen to decrease radially to reach a lowest value of 216 Kelvin.

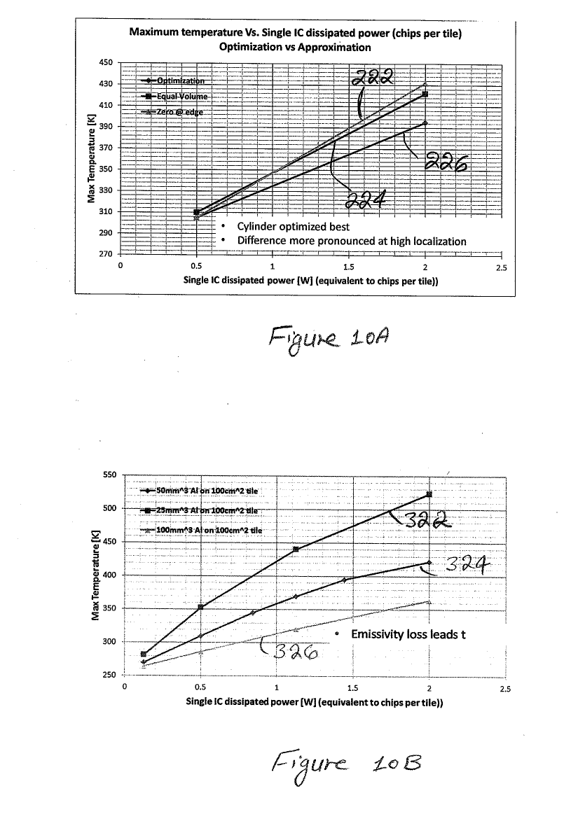

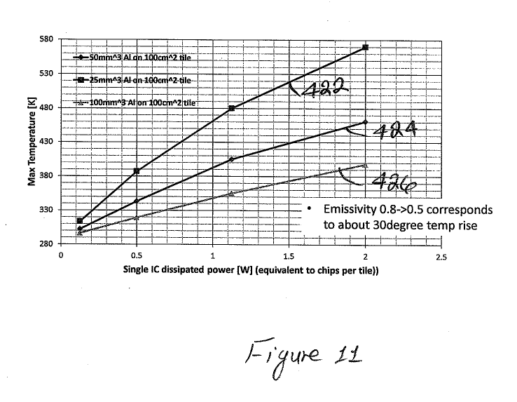

Plot 222 of FIG. 10A shows the maximum temperature in Kelvin at heat dissipating structure 102 (see FIG. 8A) as a function of the power consumed by the heat dissipating structure 102's associated IC 10. As is seen from Plot 222, the maximum temperatures at the heat dissipating structure 102 are respectively 310 and 430 Kelvin assuming that the associated IC has a wattage of 0.5 and 2.0 respectively.

Plot 224 of FIG. 10A shows the maximum temperature in Kelvin at heat dissipating structure 104 (see FIG. 8B) as a function of the power consumed by the heat dissipating structure 104's associated IC 10. As is seen from Plot 224, the maximum temperatures at the heat dissipating structure 104 are respectively 310 and 426 Kelvin assuming that the associated IC has a wattage of 0.5 and 2.0 respectively.

Plot 226 of FIG. 10A shows the maximum temperature in Kelvin at heat dissipating structure 110 (see FIG. 8C) as a function of the power consumed by the heat dissipating structure 110's associated IC 10. The same volume of heat dissipating materials are used in generating plots 222, 224 and 226. As is seen from Plot 226, the maximum temperatures at the heat dissipating structure 110 are respectively 310 and 392 Kelvin assuming that the associated IC has a wattage of 0.5 and 2.0 respectively. By comparing plots 222, 224 and 226, it is seen that heat dissipating structure 110 provides an enhanced heat dissipating function as the amount of power consumed by its associated IC increases.

Plots 322, 324 and 326 of FIG. 10B show the maximum temperature as a function of the power consumption of the IC for three different volumes of the heat dissipating structure 106 formed using Aluminum having emissivity of 0.8. Plots 322, 324 and 326 are respectively associated with heat dissipating volumes of 25 mm², 50 mm² and 100 mm² formed on a tile having an area of 100 cm². As is seen from these plots, the heat dissipating structure with the highest volume corresponding to plot 326 has the smallest slope. Therefore, an MPCS, in accordance with embodiments of the present invention, achieves optimum performance when adapted to have relatively high number of ICs operating at relatively lower powers. Plots 422, 424 and 426 are respectively similar to plots 322, 324 and 326 except that in plots 422, 424 and 426 the emissivity of the heat dissipating structure is assumed to be 0.5

In summary, the methods and techniques described herein allow the construction of a contained, modular, self-powered, self-cooling computing and digital storage platform whose size can be adapted to the computing needs. This platform could also be deployed into space to mitigate environmental impacts created by earth based solutions.

The above embodiments of the present invention are illustrative and not limitative. Embodiments of the present invention are not limited by the number of tiles, substrates, integrated circuits, photovoltaic cells, etc., used to form an MPCS. Embodiments of the present invention are not limited by the type of tiles, substrates, integrated circuits, photovoltaic cells, etc., used to form an MPCS. The systems and methods described herein allow construction of a self-contained, modular, self-powered, self-cooling computing and digital storage platform whose size may be adapted to suit the computing needs. Such a system may be used on earth or deployed into space to mitigate environmental impacts of existing earth-based systems. Other additions, subtractions or modifications are obvious in view of the present disclosure and are intended to fall within the scope of the appended claims.

What is claimed is:

1. A computer system comprising:
a substrate;
a plurality of integrated circuits disposed on a first surface of the substrate; and
a plurality of photovoltaic cells disposed on a second surface of the substrate, wherein each of the plurality of photovoltaic cells is adapted to convert sun light to electrical energy and supply the electrical energy to a different one of the plurality integrated circuits.

2. The computer system of claim 1 further comprising a control unit adapted to transfer data between the plurality of integrated circuits and a remote server.

3. The computer system of claim 1 wherein each integrated circuit is adapted to communicate with a subset of the integrated circuits, wherein said subset and the data processing unit are nearest neighbors.

4. The computer system of claim 3 wherein each integrated circuit is further adapted to communicate with a remote server wirelessly via a transmit/receive antenna.

5. The computer system of claim 2 wherein said computer system is adapted to operate in space, and wherein said control unit is adapted to maintain the second surface of the substrate facing the sun as the computer system orbits the earth.

6. The computer system of claim 1 wherein each integrated circuit comprises a data/signal processing unit.

7. The computer system of claim 6 wherein each integrated circuit further comprises a memory.

8. The computer system of claim 1 wherein said substrate is flexible.

9. The computer system of claim 8 wherein said substrate is made from a material selected from Kapton, polyimide and polytetrafluoroethylene.

10. The computer system of claim 8 further comprising a heat dissipating structure associated with each integrated circuit.

11. The computer system of claim 10 wherein each heat dissipating structure includes a plurality of concentric shapes formed using metallic or heat conducting materials.

12. The computer system of claim 11 wherein the dissipating structures are disposed on the second surface of the substrate.

13. The computer system of claim 11 wherein the dissipating structures are disposed on the first surface of the substrate.

14. The computer system of claim 10 wherein each heat dissipating structure has a tapered shaped with a thickness that decreases with distance away from the heat dissipating structure's associated integrated circuit.

15. A method of forming a computer systems, the method comprising:
forming a plurality of integrated circuits on a first surface of the substrate; and
forming a plurality of photovoltaic cells on a second surface of the substrate, wherein each of the plurality of photovoltaic cells is adapted to convert sun light to electrical energy and supply the electrical energy to a different one of the plurality of integrated circuits

16. The method of claim 15 wherein said computer system further comprises a control unit adapted to transfer data between the plurality of integrated circuits and a remote server.

17. The method of claim 15 wherein each integrated circuit is adapted to communicate with a subset of the integrated circuits, wherein said subset and the data processing unit are nearest neighbors.

18. The computer system of claim 3 wherein each integrated circuit is further adapted to communicate with a remote server wirelessly via a transmit/receive antenna.

19. The method of claim 16 wherein said computer system is adapted to operate in space, the method comprising:
maintaining the second surface of the substrate facing the sun as the computer system orbits the earth.

20. The method of claim 15 wherein each integrated circuit comprises a data/signal processing unit.

21. The method of claim 16 wherein each integrated circuit further comprises a memory.

22. The method of claim 15 wherein said substrate is flexible.

23. The method of claim 22 wherein said substrate is made from a material selected from Kapton, polyimide and polytetrafluoroethylene.

24. The method of claim 22 further comprising:
forming a heat dissipating structure associated with each integrated circuit.

25. The method of claim 24 wherein each heat dissipating structure includes a plurality of concentric shapes formed using metallic or heat conducting materials.

26. The method of claim 25 wherein the dissipating structures are disposed on the second surface of the substrate.

27. The method of claim 25 wherein the dissipating structures are disposed on the first surface of the substrate.

28. The method of claim 22 wherein each heat dissipating structure has a tapered shaped with a thickness that decreases with distance away from the heat dissipating structure's associated integrated circuit.
